(19) United States
(12) Patent Application Publication
(10) Pub. No.: US 2025/0139453 A1
(43) Pub. Date: May 1, 2025

(54) RELIABLE MODEL EXCHANGE AND AGGREGATION SCORE IN DECENTRALIZED FEDERATED LEARNING

(71) Applicant: Dell Products L.P., Round Rock, TX (US)

(72) Inventors: Leandro Takeshi Hattori, Campo Grande – MS (BR); Pedro Fratini Chem, Porto Alegre – RS (BR); Vítor Nascimento Lourenço, Niterói – RJ (BR); Thais Luca Marques de Almeida, São Gonçalo – RJ (BR); Jonathan Mendes De Almeida, Brasília – DF (BR); Alexander Eulalio Robles Robles, Valinhos – SP (BR)

(21) Appl. No.: 18/494,625

(22) Filed: Oct. 25, 2023

(51) Int. Cl. G06N 3/098

(52) U.S. Cl. CPC G06N 3/098

(57) ABSTRACT

One example method includes, at a client that is part of a group of clients, where each client in the group is able to communicate with the other clients of the group, performing operations that include training a machine learning (ML) model hosted at the client, based on predictions generated by the ML model in response to input data received by the ML model, labeling selected data of the input data, retraining the ML model, to create an updated ML model, using the selected data, computing a set of metrics based on performance of the updated ML model, compiling the set of metrics into a reliable model exchange and aggregation score (RMEAS), and based on the RMEAS, determining whether to engage in an exchange, with one or more of the other clients, involving the updated ML model.

### FIELD OF THE INVENTION

Embodiments of the present invention generally relate to decentralized federated learning. More particularly, at least some embodiments of the invention relate to systems, hardware, software, computer-readable media, and methods, for identifying ML (machine learning) model deficiencies at one or more clients, and updating the ML model after any deficiencies are identified.

### BACKGROUND

In a distributed environment where an ML model is deployed by a central node to a group of edge nodes, reliance on a centralized ML model training and validation process often leads to bandwidth, privacy, and security concerns. To address these challenges, Decentralized Federated Learning (DFL) procedures have been implemented. A DFL approach may be scalable, and it does not depend on a central node for orchestration of the training and deployment of the ML model. Since the individual node information is not centralized in a specific location, and data is not transmitted beyond the node, a DFL approach may maintain a higher level of security and data privacy than would be achievable with a centralized ML model training and validation process.

The success of DFL may depend heavily on the ability to exchange models effectively and securely with the clients involved. Without a reliable model exchange system, it can be difficult to determine which clients are following suitable protocols in the model workflow and to keep the data private and secure. This scenario can lead to an increased risk of malicious actors introducing compromised models into the DFL.

The following are examples of particular challenges in a conventional DFL approach. One such challenge concerns the need to avoid issues that can cause, or generate, unbeneficial model aggregation among nodes. Another challenge is to exchange models, between nodes, effectively in a DFL setting, while respecting bandwidth limits and privacy requirements. Yet another challenge is to provide the nodes with more autonomy in an ML model exchange and aggregation processes, while maintaining data privacy and ML model reliability in a decentralized manner.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture and methods, according to one embodiment.

FIG. 2 discloses aspects of an AL (active learning) process, according to one embodiment.

FIG. 3 discloses an example algorithm for carrying out a method for ML model exchange, according to one embodiment.

FIG. 4 discloses an example computing entity operable to perform any of the disclosed methods, processes, and operations.

### DETAILED DESCRIPTION OF SOME EXAMPLE EMBODIMENTS

Embodiments of the present invention generally relate to decentralized federated learning. More particularly, at least some embodiments of the invention relate to systems, hardware, software, computer-readable media, and methods, for identifying ML (machine learning) model deficiencies at one or more clients, and updating the ML model after any deficiencies are identified.

In one example embodiment, an architecture of a client, such as an edge node for example, comprises an ML workflow module (MLWM), a score calculation module (SCM), and a model exchange module (MEM). In an embodiment, a trained external ML model, or simply ‘model,’ may be deployed to, and received by, each client in a group of clients. The external ML model, which may be deployed as an element of the MLWM, may generate output in the form of inferences, such as predictions, based on data generated at, and/or received by, the client. An artifact, comprising (1) the input data to the model, and (2) the output of the model, may be output by the model to both an AL (active learning) pipeline and a DD (drift detection) pipeline. Both pipelines may be elements of the MWLM.

The AL pipeline may evaluate the artifact(s) and determine whether or not the artifact(s) should be labeled, such as by a human operator or other oracle. Any data identified for labeling may be stored, and then labeled. The DD pipeline, executed concurrently or sequentially with the AL pipeline, may monitor the data, of the artifacts, for drift. If/when drift is detected, an alarm may be sent to the AL pipeline.

The labeled data may be loaded into an ML pipeline and used to update the local model at the client. The updated local model may be sent to the MEM, and to the SCM where an RMEAS (reliable model exchange and aggregation score), which may comprise multiple different model reliability scores specific to the client, is generated that indicates the reliability of the updated local model.

Candidate clients for exchanging their respective models may then be identified. Each of the candidates may then compute a respective RMEAS, and a protocol applied to determine which client(s) will take place in the model exchange. The updated model may then be exchanged with the candidates, and the client may receive, as part of the exchange, an external model from one of the clients. This external model may be evaluated by the receiving client, and the results of the evaluation sent to the node from which the external model was received. If the external model meets or exceeds a defined threshold, such as in terms of its performance, then a final aggregated model comprising the updated local model and the external model may then be deployed at the client.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that ML model updates may be implemented, in a decentralized environment, while maintaining the privacy of data at the individual nodes where the ML model runs. In an embodiment, an updated model that meets performance criteria may be deployed to nodes of a group so that the collective performance of the group is improved through use of the updated model. Various other advantages of one or more example embodiments will be apparent from this disclosure.

### A. Context for an Example Embodiment

The following is a discussion of an example context for various embodiments of the invention. This discussion is not intended to limit the scope of the invention, or the applicability of the embodiments, in any way.

### A.1 Decentralized Federated Learning (DFL)

DFL may leverage the power of decentralized networks to train ML models without a central server. This strategy may be useful for devices on the edge of the network, such as smartphones, IoT (Internet of Things) devices, and other sensors.

### A.2 Active Learning (AL)

AL is a useful mechanism in the continuous training process. In general, AL may perform data selection, selecting only the most informative data points for labeling from the pool of unlabeled data. An annotator entity may be used to label those data points, and the labeled data used to train an ML model.

### A.3 Drift Detection (DD)

In general, DD mechanisms aim to identify changes in the collected data that is fed to a model for inferencing. These changes can lead to model performance degradation, which may thus implicate the use of AL mechanisms for model training at the edge.

### B. Overview of Aspects of an Example Embodiment

In an embodiment, problems such as those noted herein may be prevented by evaluating the quality of an ML model development process through a score-based system that monitors each step. Thus, an embodiment comprises an approach that provides a Reliable Model Exchange and Aggregation Score (RMEAS) in a DFL context.

Active Learning (AL) and Drift Detection (DD) are approaches used to label samples efficiently and monitor a model for drift, respectively. AL involves selecting the most informative samples for labeling to optimize the labeling budget, while DD involves identifying and addressing changes in the data distribution. In an embodiment, both techniques may be applied to a DFL client setting, to ensure an efficient and relevant model. An embodiment may also calculate metrics from AL and DD approaches that may be used to compose an RMEAS. This score may be used to support autonomous decision making, by one or more clients, during a model exchange and aggregation process in the DFL approach, so as to create an end-to-end approach.

### C. Introduction to Aspects of an Example Embodiment

### C.1 Brief Discussion of One Example Embodiment

DFL may address bandwidth, privacy, and security issues in centralized model training, but it requires a reliable, effective, and secure model exchange mechanism. Thus, an embodiment comprises an approach to provide autonomous decision-making during model exchange and aggregation in a DFL framework using a score-based system. To generate such a score, an embodiment may employ an approach referred to herein RMEAS-DFL, which may be divided into the following modules, respective instances of which may be deployed at each node in a group of nodes:
[1] Machine Learning Workflow Module (MLWM)—an embodiment of the MLWM may perform the ML training phases, which includes the data collection, data selection using AL, and data monitoring DD. Next, the Oracle (e.g., human expert) will perform the data labeling for all selected data. Then, the pipeline re-trains the model using the data labeled and deploys it to make the model available for exchange and aggregation;
[2] Score Calculation Module (SCM)—an embodiment of the SCM may compute a set of metrics to ensure system performance. The SCM may rely on the AL to extract uncertainty measure of the model predictions, and on DD to determine if the data distribution has changed significantly since the deployment of the last model. Additionally, the SCM may check the labels provided by an oracle, with the model predictions. This ensemble of metrics may be compiled into a score, which is defined herein as RMEAS; and
[3] Model Exchange Module (MEM)—an embodiment of this module may implement sharing and receiving the RMEAS values from the available client nodes. Next, the MEM may decide whether to exchange client models, based on an agreement protocol. In the case of model exchange, the received model is evaluated locally, that is, using data local that is local to the client. Also, if the external model meets one or more defined criteria, external and local models may be aggregated together by the MEM, and the new model, comprising the aggregation of the external model and the local model, may then be deployed to the clients.

### C.2 Further Aspects of an Example Embodiment

An embodiment comprises an approach that includes the generation of a score that measures the efficacy of exchanging models in a DFL context. An embodiment integrates AL and DD techniques to create a score-based method that generates a score referred to herein as RMEAS. A method according to one embodiment enables maintenance of an ML model to ensure that the model is updated, and relevant. An embodiment may use calculated metrics to compose the RMEAS in a way that enables clients to analyze the performance of external models. The RMEAS may be used as a basis to implement a model exchange without accessing external client data or system. In an embodiment, the DFL framework integrating these three modules, namely, DFL, AL, and DD, may provide improvements in system reliability, security, and performance.

### C.2.1 Reliability

The RMEAS-DFL approach according to one embodiment provides a reliable mechanism for model exchange and aggregation by using a score-based system to measure the efficacy of each model exchanged. In an embodiment, the metrics used, which include accuracy, drift detection, Oracle labeling effectiveness ratio, and last model exchange date, may ensure that the models exchanged are relevant and up to date. With respect to the Oracle labeling effectiveness ratio, this metric is configured to quantify the efficiency with which data is labeled by the Oracle, as transmitted through the active learning pipeline.

An embodiment may enable experimental verification of model performance which, in turn, may enable clients to verify the performance of the external model in their own environment, further increasing reliability to perform more autonomous model exchange decision making.

### C.2.2 Security

In an embodiment, the RMEAS-DFL approach addresses security concerns by providing a score-based system that ensures the models being exchanged are reliable in terms of their performance. In an embodiment, the system enables users to define a model exchange agreement protocol, providing an additional layer of security since, in an embodiment, only authorized clients can participate in the model exchange. In an embodiment, the system at one client collects RMEAS from other clients, enabling the comparison of metrics and score generation. In an embodiment, the system does not share the data or model weights, whether the agreement is complete, ensuring confidentiality in the model transaction.

### C.2.3 Performance

An embodiment may improve the DFL performance by ensuring that only relevant and reliable models are being aggregated for use by the clients. By measuring metrics such as model prediction uncertainty, model performance and drift detection, an embodiment of the system ensures that the models exchanged between/among clients are of high quality, improving the overall performance of the DFL approach across the nodes in a group of nodes. In an embodiment, an experiment verification operation may improve performance by enabling clients to verify the performance of the external model in their environment, further increasing the efficacy of the DFL approach.

### D. Detailed Discussion of an Example Embodiment

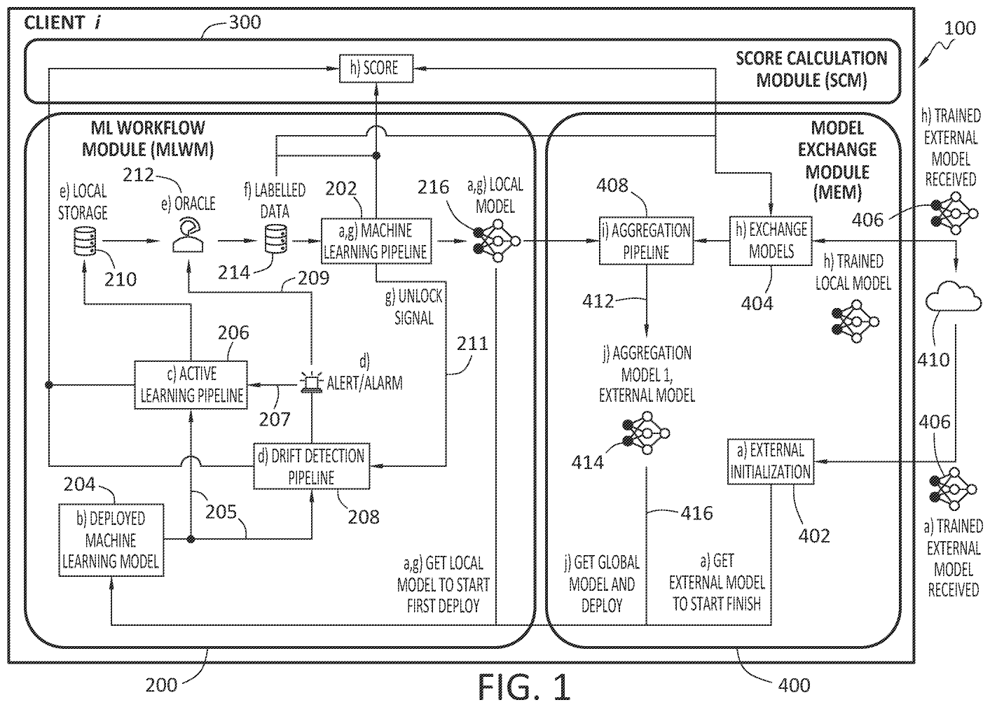

As noted earlier, an embodiment may comprise various modules. With attention now to FIG. 1, an example architecture, such as may be implemented in a client that is a member of a group of clients, where each of the clients is configured to communicate with each other, and where one or more of the clients may comprise, for example, an edge node. Example edge nodes include, but are not limited to, mobile communication devices, sensors, and IoT devices, and combinations of these. In the example of FIG. 1, a client 100 may comprise an MLWM 200, SCM 300, and MEM 400, and each of these components may be configured and operable to communicate with the others. These example components are considered in turn below.

### D.1 MLWM (Machine Learning Workflow Module)

In an embodiment, the MLWM 200 performs the operations to maintain a local deployed model that is updated and relevant, and that performs in accordance with established criteria. As well, the MLWM 200 may offers a local model to the MEM 300, and metrics of various approaches to the SCM 400. With continued reference to FIG. 1, the operation of the example MLWM 200 is described in detail as follows.

An initial model may be deployed that may be generated by an ML pipeline 202 or by an external initialization 402, as shown in FIG. 1 (at a, g). After deployment, the deployed ML model 204 starts to perform predictions on a stream of data. The generated artifacts 205, each of which may comprise (1) an output of the ML model 204, and (2) the input data based on which that output was generated by the ML model 204, are redirected to an AL pipeline 206 and a DD pipeline 208. The activities of the MLWM performed in these two modules are described next.

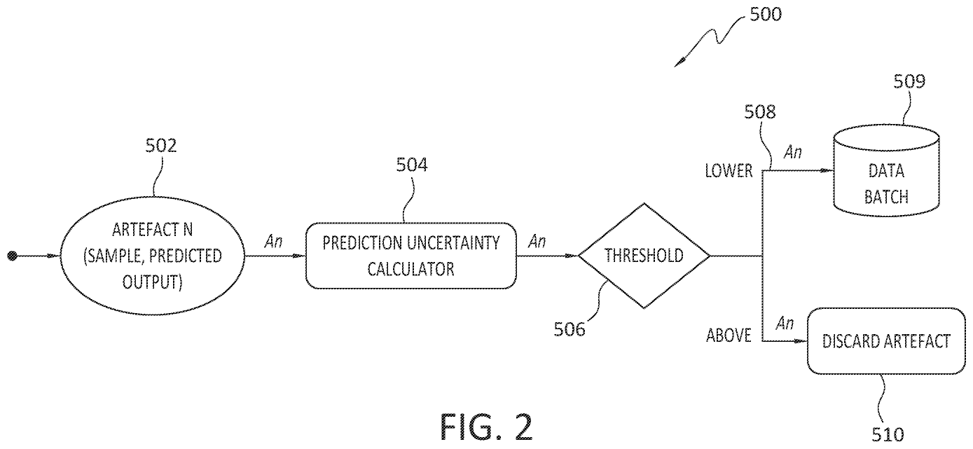

In particular, the AL pipeline processes the streamed artifacts 205 received by the ML model 204, which may comprise an inference ML model. For each artifact 205, the AL pipeline 206 decides, possibly based on a threshold value, whether or not to store the artifact 205 for labelling. This threshold value may be used to select only the most relevant samples for labelling, thus optimizing a labelling budget. Multiple approaches from stream-based AL may be employed in this context, and some example strategies consider prediction uncertainty, sample diversity, or a combination of both, as the key information to filter for data samples that should be labeled. One example embodiment may assume the prediction Uncertainty Samples (US) as the criterion. An example sample selection process 500 is disclosed in FIG. 2, which shows a scheme for the selection of the most relevant samples in AL.

As shown in FIG. 2, the process 500 may involve the reception 502 of various artifacts. For each artifact, the AL module calculates 504 the prediction uncertainty and compares 506 that prediction uncertainty with a pre-defined threshold. If the calculated 504 value is below the threshold, the artifact is stored 508 in a data batch 509, otherwise the artifact is discarded 510. Some examples of prediction uncertainty measures that may be employed in one or more embodiments include:
1. One (1) minus the value of the most probable class (Least Confidence);
2. One (1) minus the difference between the values of first and second most probable classes (Margin of Confidence); and
3. Calculating the Shannon Entropy measure for the predicted class values.
   When the data batch 509 reaches a pre-defined number of samples, or based on a timer system, the AL pipeline 206 forwards the data to the local storage 210. This multi-edge interaction may help to avoid overloading the computational capabilities of the MLWM 200.

With continued reference now to FIG. 1, further attention is directed to aspects of the MLWM 200 operations. In particular, the DD mechanism of the DD pipeline 208 may be executed concurrently or sequentially to the AL module 206 as shown in FIG. 1 (at d.).

This operation focuses on monitoring data streams over a time t to detect changes in their statistical properties and/or the underlying concepts, where such changes may indicate drift. Then, the DD pipeline 208 compares the current data distribution or/and model performance with a distribution or/and performance Pₜ (X,y).

In case of change in the joint distribution between two instances t and t+τ, where t is a particular time point or time interval, and t+τ denotes the time window when the distribution changes are being checked, concept drift occurs, if P_t (X,y)≠P_(t+τ) (X,y). Also, to make the approach more robust to outliers:

$$∀ i , τ = {τ}_{{d}^{( i + 1 )}} - {τ}_{{d}^{( i )}} > 1 ,$$

where τ∈Z⁺ is the time point and d⁽ⁱ⁾ denotes the time points order of the i-th concept drift detected by the system. All parameters may be adjusted according to the requirements of the user of the system.

The following mechanism enables implementing the framework, according to an embodiment at the edge: when a drift is detected, an alarm signal 207 is sent to the AL 206, and a new threshold T_{new} is defined, where T_{new}<T. The purpose of this change is to select more information about the environment and adapt the ML model 204 accordingly. Moreover, in order to warn that a problem may occur de to the presence of drift, an alarm signal 209 (FIG. 1.d) may be sent to the Oracle 212 (FIG. 1-e). This behavior may continue until a new model is trained and deployed.

As noted earlier herein, the selected data is sent to local storage 210, where a human annotator or an expert (Oracle) 212 may be responsible for providing labels for a subset of unlabeled data points. This data is stored in a strongly labeled data (SLD) storage 214 (FIG. 1.f) to perform another training process. In particular, the data in SLD 214 may be loaded into the ML pipeline 202, and pre-processing and feature engineering stages may be applied by the ML pipeline 202 to the data. Then, a train step may be performed to obtain an updated local model 216 to be deployed as the deployed ML model 204. If the DD alarm signal is activated, the ML pipeline 202 may send an unlock signal 211 to the DD pipeline 208 to return to normal conditions (FIG. 1.g). The updated local model 216 may also be sent to the MEM 400.

### D.2 SCM (Score Calculation Module)

With continued attention to FIG. 1, further details are provided concerning the example SCM 300. In general, the RMEAS is a score computed in the SCM that assesses the reliability of a client's ML model. FIG. 1.h shows the details of the SCM 300 interaction with various other aspects and elements of an example embodiment, which draws on metrics from various sources. In an embodiment, the AL pipeline 206, the DD pipeline 208, Oracle 212, and the ML pipeline 202 are elements that may participate in an RMEAS calculation process. This ensemble may be used to compile a score that may then be made available to be shared with other clients.

With particular reference to the AL pipeline 206 approach, an embodiment may use the uncertainty score S_{AL} of the model predictions to assess the reliability of the ML model 204. In an embodiment, this uncertainty score may be calculated by analyzing the ratio of US to observed samples O, by the following equation:

$${S}_{AL} = 1 - \frac{US}{O} .$$

Additionally, uncertainty metrics for each class may be examined to consider the diversity of class selection and the amount of data sent. In this example, an embodiment considers only the overall uncertainty of the classes.

To evaluate the Oracle 212, for example, an embodiment may measure the percentage of the evaluate data sent from the AL pipeline 206. Let E be the amount of data labeled by the Oracle 212, and US the number of data points sent by the AL pipeline 206—then this can be calculated using the following equation:

$${S}_{O} = \frac{E}{US}$$

To determine the agreement rate between the Oracle 112 output and the ML model 204 output, an embodiment may compare the predictions made by both the Oracle 112 and the ML model 204. Thus, let M be the number of predictions that match between the Oracle 112 and the ML model 204, and let T be the total number of predictions made. The agreement rate may be calculated using the following equation:

$${S}_{agree} = \frac{M}{T}$$

The agreement rate represents the proportion of predictions on which the Oracle 112 and the ML model 204 agree.

To evaluate the performance of a model developed from the ML pipeline 202, an embodiment may use a test set to generate metrics such as the F1—score, for example. The F1—score may be calculated using the following equation:

$$F 1 = 2 * \frac{precision * recall}{precision + recall}$$

where precision and recall are calculated as follows:

$$\begin{matrix}precision = \frac{TP}{TP + FP} , \\ recall = \frac{TP}{TP + FP} ,\end{matrix}$$

where True Positives (TP) are the number of samples that are correctly predicted as positive, False Positives (FP) are the number of samples that are incorrectly predicted as positive, and False Negatives (FN) are the number of samples that are incorrectly predicted as negative.

To continue, the equation for the score based on DD could be expressed as follows:

$${S}_{DD} = \{ \begin{matrix}0 , & if drift detected since last retraining or model exchange ; \\ 1 , & otherwise .\end{matrix}$$

In this case, the score is either 0 or 1, depending on whether a drift has been detected since the last retraining or model exchange. If a drift is detected, the score is 0, indicating that the model needs to be retrained or exchanged to maintain its performance. If no drift is detected, the score is 1, meaning that the model does not require any.

Further, the exchange S_{E}, may be represented as shown in the following equation:

$${S}_{E} = ω * ρ * exp ( - k * t ) ,$$

where ω is a weight factor representing the performance of the model in the external test set, ranging from 0 to 1, for example F1—score, where higher values indicate better performance. ρ is a participation factor, ranging from 0 to 1. This factor represents the degree of participation in the model exchange.

A value of 0 indicates no attempt to exchange models, while a value of 1 indicates a successful model exchange. If the client at least tried to exchange their model, but the exchange was unsuccessful, ρ is set to 0.25, for example. k is the degradation rate, and t is the time elapsed since the last update. The exponential term exp(−k*t) ensures that ρ decreases over time, and the final value of S_{E} decreases accordingly.

The degradation rates k determine how quickly the value of ρ decays over time. A higher value of k indicates a faster decay, while a lower value of k indicates a slower decay. The degradation rates k can be set based on the expected decay rate of ρ over time in the given context.

The various scores described above may be sent to an interested external node, or nodes, which may integrate all these scores into a single overall score, using a weighted sum approach, in one embodiment.

In particular, let w_{AL}, w_{O}, w_{ML}, w_{DD}, and w_{E} be the respective weights assigned to each of the reliability scores obtained from the AL pipeline 206, the Oracle 212, the ML pipeline 202, the DD pipeline 208, and the exchange model approaches, respectively. The overall score RMEAS may then be calculated using the following equation:

$$RMEAS = {w}_{AL} \times {S}_{AL} + {w}_{0} \times {S}_{0} + {w}_{ML} \times F 1 + {w}_{DD} \times {S}_{DD} + {w}_{E} \times {S}_{E}$$

where the weights may be chosen based on their relative importance to the task at hand and needs to be received from the external client.

For example, if the model reliability is the most important, a higher weight may be assigned to the AL score and a lower weight to the ML score. Conversely, if model performance is more important, then a higher weight may be assigned to the ML score and a lower weight to the AL score.

### D.3 MEM (Model Exchange Module)

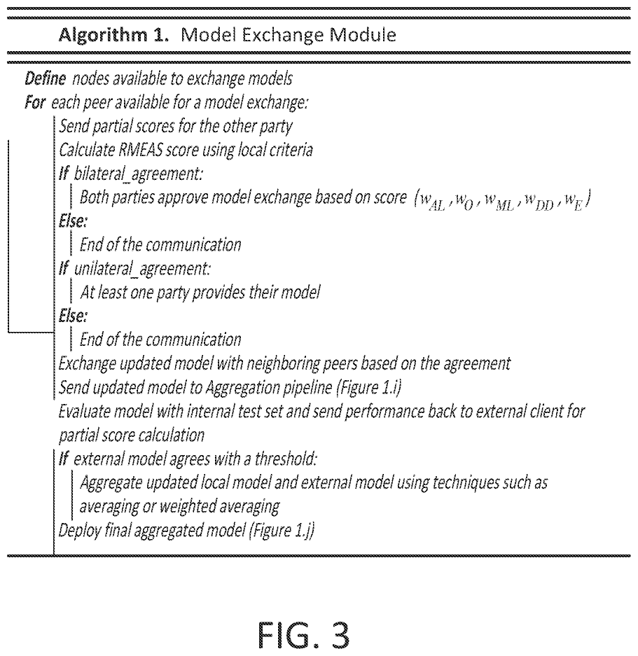

To further enhance the collaborative aspect of one embodiment, the embodiment may integrate the RMEAS protocol into the MEM 400. By sharing the RMEAS with other nodes, a client 100 may compare its own metrics with those of other clients and generate an overall score for the ML model 204. This score can then be used to determine whether to exchange the ML model 204 with other clients in the DFL approach. An example approach for model exchange, according to one embodiment, is embodied in Algorithm 1 of FIG. 3. Algorithm 1 may be run in/by the MEM 400.

In an embodiment, the first operation of the Algorithm 1 is to define nodes that are available to exchange their respective models. If an interested peer with which to exchange models is found, each client may send its partial scores for the other part and, based on their local criteria, namely (w_{AL}, w_{O}, w_{ML}, w_{DD}, and w_{E}), the interested peer, or client, calculates the RMEAS, as discussed above.

In an embodiment, the RMEAS protocol enables the creation of a model exchange agreement protocol, which can be bilateral or unilateral, based on local user criteria. In the case of a bilateral agreement, both parties, or clients, must approve the model exchange, while in the case of a unilateral agreement, only one party needs to provide their model. For example, clients i and j engage in a bilateral or unilateral RMEAS protocol to compare their respective model scores RMEASᵢ and RMEASⱼ. The protocol returns a Boolean value:

$$E ( {RMEAS}_{i} , {RMEAS}_{j} ) = \{ \begin{matrix}1 , & if bilateral agreement or unilateral agreement from i to j \\ 0 , & otherwise\end{matrix}$$

In the MEM 400, when the updated local model 216 is exchanged 404 with neighboring peers, the external model 406 is sent to an aggregation pipeline 408 (FIG. 1.i) and the external model 406 is evaluated with an internal test set. The performance results of this evaluation are sent back to the external client 410 to compose their partial score. The evaluation may also be used to define the model aggregation, or not, internally to the MEM 400. In case the external model 406 meets an established threshold of performance, this external model 406 may be aggregated 412, by the aggregation pipeline 408, together with the updated local model 216 using techniques such as averaging or weighted averaging. Then, the final aggregated model 414 is then deployed 416 (FIG. 1.j).

### E. Example Use Cases

### E.1 Smart Cities

In the field of autonomous vehicles and smart cities, a fleet of self-driving cars are being developed to navigate crowded city streets. To improve their performance, a DFL approach is suitable to be employed, in which the cars would communicate with each other and exchange ML models. The models are trained on data collected from sensors installed on each car, such as LIDAR and cameras.

However, as the environment changes, the performance of the models may suffer due to data drift. To address this issue, a drift detection mechanism can be implemented to constantly monitor the model performance and detect when the model starts to deviate from its expected behavior. When drift is detected in the performance of the model(s), the models are flagged, and an active learning mechanism is initiated. This allows the models to learn from new data and improve their performance.

To further enhance the collaborative aspect of the approach, the RMEAS protocol is integrated into the DFL approach. By sharing the RMEAS score with other vehicles, each of the cars can compare their own metrics with those of other cars and each can generate an overall score for their respective modes. This score may then be used by a car to determine whether to exchange the model with other cars, in the DFL approach.

When the updated model is exchanged with neighboring cars, the updated model is sent to an aggregation pipeline and evaluated with an internal test set. In case of agreement between the updated model and the internal test set, the updated model is then aggregated together with the updated local model, using techniques such as averaging or weighted averaging for example. The final, aggregated, model is then deployed to all the cars in the fleet, leading to improved performance and reliability across the population of cars.

To ensure the security and privacy of the exchanged models, differential privacy and cryptography techniques may be employed. The cars are also equipped with data compression techniques to reduce the size of exchanged models and to enable the implementation of ML solutions on resource-constrained devices.

Finally, according to one embodiment, the DFL framework with a score-based protocol, namely, RMEAS, may provide a comprehensive solution for effective model exchange and aggregation in the fleet of autonomous vehicles. This leads to improved performance, reliability, and safety of self-driving cars, benefiting the customers and society.

### D.2 Space Miner Exploration

Consider a scenario where a company plans to launch a fleet of rovers to explore the moon in search of valuable resources. To ensure the success of this mission, each rover is equipped with a state-of-the-art ML model, which is designed to analyze the lunar surface for signs of valuable minerals.

The problem is that each rover has its own unique set of sensors and data sources, making it difficult to share information and collaborate effectively among the rovers. To address this challenge, the space exploration company decided to implement a DFL approach, which allows each rover to train its own ML model on its local data, and then exchange and aggregate models with other rovers.

To facilitate this model exchange, the rovers will use the RMEAS protocol disclosed herein. This score-based protocol will enable the rovers to compare their own model performance with that of other rovers and then generate an overall score, which will determine whether to exchange their models.

The decentralized nature of this application and environment also allows the rovers to work autonomously, without the need for constant communication with Earth-based controllers. Each rover can continue to collect data and train its own model, and periodically exchange and aggregate models with other rovers to improve their collective performance.

Considering this dynamic environment, an embodiment may potentially enhance the reliability and performance of each individual rover and increase the overall success of the mission. By working together and exchanging models, the rovers can cover more ground and discover valuable resources faster than they would be able to individually.

This approach may also have significant implications for the space exploration industry. By utilizing DFL and RMEAS protocols, private space exploration companies can improve the effectiveness of their missions, reduce costs, and increase the speed of their discoveries. Additionally, the technology can be applied to other areas of space exploration and even beyond, such as in autonomous vehicles and other resource-constrained environments.

### F. Example Methods

It is noted with respect to the disclosed methods, including the example method of FIGS. 1 and 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments of the invention. These are presented only by way of example and are not intended to limit the scope of the invention in any way.

Embodiment 1. A method, comprising: at a client that is part of a group of clients, where each client in the group is able to communicate with the other clients of the group, performing operations comprising: training a machine learning (ML) model hosted at the client; based on predictions generated by the ML model in response to input data received by the ML model, labeling selected data of the input data; retraining the ML model, to create an updated ML model, using the selected data; computing a set of metrics based on performance of the updated ML model; compiling the set of metrics into a reliable model exchange and aggregation score (RMEAS); and based on the RMEAS, determining whether to engage in an exchange, with one or more of the other clients, involving the updated ML model.

Embodiment 2. The method as recited in any preceding embodiment, wherein the selected data is labeled by an oracle.

Embodiment 3. The method as recited in any preceding embodiment, wherein computing a set of metrics comprises: determining an uncertainty measure corresponding to the predictions; determining whether drift has occurred in the input data provided to the ML model; and determining a reliability measure indicating whether labels of the selected data match with the predictions.

Embodiment 4. The method as recited in any preceding embodiment, wherein determining whether to engage in the exchange involving the updated model comprises sharing the RMEAS with one or more of the other clients and/or comparing the RMEAS with a respective RMEAS received from one or more of the other clients.

Embodiment 5. The method as recited in any preceding embodiment, wherein determining whether to engage in the exchange involving the updated ML model is based on an agreement protocol between the client and one or more of the other clients.

Embodiment 6. The method as recited in any preceding embodiment, wherein when a determination is made to engage in the exchange, the client receives an external ML model from one of the other clients.

Embodiment 7. The method as recited in embodiment 6, wherein the client performs an evaluating process that comprises using the data to evaluate a performance of the external ML model.

Embodiment 8. The method as recited in embodiment 7, wherein when the evaluating process indicates that the performance of the external ML model meets one or more established criteria, the external model is aggregated together with the updated model to produce an aggregated model that is then deployed at the client.

Embodiment 9. The method as recited in any preceding embodiment, wherein an artifact is generated that comprises the input data to the ML model and the predictions generated based on that input data, and the artifact is provided to a drift detection module which determines whether drift has occurred in the ML predictions and/or in the input data.

Embodiment 10. The method as recited in any preceding embodiment, wherein no local data of the nodes is exchanged during performance of the operations.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

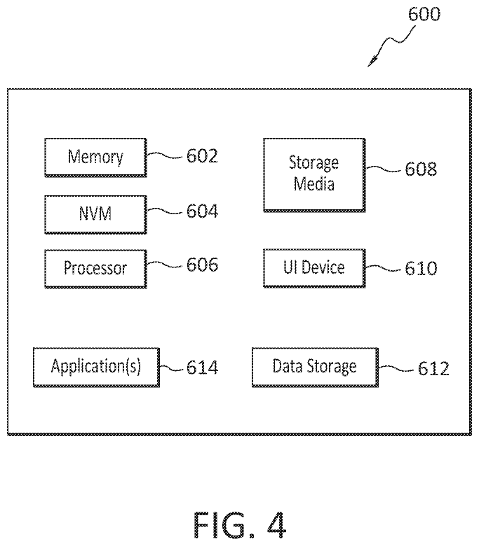

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 4.

In the example of FIG. 4, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
at a client that is part of a group of clients, where each client in the group is able to communicate with the other clients of the group, performing operations comprising:
training a machine learning (ML) model hosted at the client;
based on predictions generated by the ML model in response to input data received by the ML model, labeling selected data of the input data;
retraining the ML model, to create an updated ML model, using the selected data;
computing a set of metrics based on performance of the updated ML model;
compiling the set of metrics into a reliable model exchange and aggregation score (RMEAS); and
based on the RMEAS, determining whether to engage in an exchange, with one or more of the other clients, involving the updated ML model.

2. The method as recited in claim 1, wherein the selected data is labeled by an oracle.

3. The method as recited in claim 1, wherein computing a set of metrics comprises:
determining an uncertainty measure corresponding to the predictions;
determining whether drift has occurred in the input data provided to the ML model; and
determining a reliability measure indicating whether labels of the selected data match with the predictions.

4. The method as recited in claim 1, wherein determining whether to engage in the exchange involving the updated model comprises sharing the RMEAS with one or more of the other clients and/or comparing the RMEAS with a respective RMEAS received from one or more of the other clients.

5. The method as recited in claim 1, wherein determining whether to engage in the exchange involving the updated ML model is based on an agreement protocol between the client and one or more of the other clients.

6. The method as recited in claim 1, wherein when a determination is made to engage in the exchange, the client receives an external ML model from one of the other clients.

7. The method as recited in claim 6, wherein the client performs an evaluating process that comprises using the data to evaluate a performance of the external ML model.

8. The method as recited in claim 7, wherein when the evaluating process indicates that the performance of the external ML model meets one or more established criteria, the external model is aggregated together with the updated model to produce an aggregated model that is then deployed at the client.

9. The method as recited in claim 1, wherein an artifact is generated that comprises the input data to the ML model and the predictions generated based on that input data, and the artifact is provided to a drift detection module which determines whether drift has occurred in the ML predictions and/or in the input data.

10. The method as recited in claim 1, wherein no local data of the nodes is exchanged during performance of the operations.

11. A non-transitory storage medium having stored therein instructions that are executable by one or more hardware processors to:
at a client that is part of a group of clients, where each client in the group is able to communicate with the other clients of the group, perform operations comprising:
training a machine learning (ML) model hosted at the client;
based on predictions generated by the ML model in response to input data received by the ML model, labeling selected data of the input data;
retraining the ML model, to create an updated ML model, using the selected data;
computing a set of metrics based on performance of the updated ML model;
compiling the set of metrics into a reliable model exchange and aggregation score (RMEAS); and
based on the RMEAS, determining whether to engage in an exchange, with one or more of the other clients, involving the updated ML model.

12. The non-transitory storage medium as recited in claim 11, wherein the selected data is labeled by an oracle.

13. The non-transitory storage medium as recited in claim 11, wherein computing a set of metrics comprises:
determining an uncertainty measure corresponding to the predictions;
determining whether drift has occurred in the input data provided to the ML model; and
determining a reliability measure indicating whether labels of the selected data match with the predictions.

14. The non-transitory storage medium as recited in claim 11, wherein determining whether to engage in the exchange involving the updated model comprises sharing the RMEAS with one or more of the other clients and/or comparing the RMEAS with a respective RMEAS received from one or more of the other clients.

15. The non-transitory storage medium as recited in claim 11, wherein determining whether to engage in the exchange involving the updated ML model is based on an agreement protocol between the client and one or more of the other clients.

16. The non-transitory storage medium as recited in claim 11, wherein when a determination is made to engage in the exchange, the client receives an external ML model from one of the other clients.

17. The non-transitory storage medium as recited in claim 16, wherein the client performs an evaluating process that comprises using the data to evaluate a performance of the external ML model.

18. The non-transitory storage medium as recited in claim 17, wherein when the evaluating process indicates that the performance of the external ML model meets one or more established criteria, the external model is aggregated together with the updated model to produce an aggregated model that is then deployed at the client.

19. The non-transitory storage medium as recited in claim 11, wherein an artifact is generated that comprises the input data to the ML model and the predictions generated based on that input data, and the artifact is provided to a drift detection module which determines whether drift has occurred in the ML predictions and/or in the input data.

20. The non-transitory storage medium as recited in claim 11, wherein no local data of the nodes is exchanged during performance of the operations.
